(19) United States
(12) Patent Application Publication
(10) Pub. No.: US 2023/0196125 A1
(43) Pub. Date: Jun. 22, 2023

(54) TECHNIQUES FOR RANKED HYPERPARAMETER OPTIMIZATION

(71) Applicant: Capital One Services, LLC, McLean, VA (US)

(72) Inventor: Michael LANGFORD, Plano, TX (US)

(73) Assignee: Capital One Services, LLC, McLean, VA (US)

(21) Appl. No.: 17/553,290

(22) Filed: Dec. 16, 2021

(51) Int. Cl. G06N 3/12

(52) U.S. Cl. CPC G06N 3/126

(57) ABSTRACT

Various embodiments are generally directed to techniques for optimizing hyperparameters, such as optimizing different combinations of hyperparameters, for instance. Some embodiments are particularly directed using a genetic or Bayesian algorithm to identify and optimize different combinations of hyperparameters for a machine learning (ML) model. Many embodiments construct a search using a genetic algorithm that prioritizes the most important hyperparameters in influencing model performance.

### FIELD

The present disclosure relates generally to the field of data processing and artificial intelligence. In particular, the present disclosure relates to devices, systems, and methods for ranked hyperparameter optimization.

### BACKGROUND

In machine learning, a hyperparameter is typically a parameter whose value is used to control the learning process. Examples of hyperparameters include learning rate and mini-batch size. By contrast, the values of other parameters (e.g., node weights) are typically derived via training. Given the hyperparameters, the training algorithm learns the parameters from the data. Oftentimes, different model training algorithms utilize different sets of hyperparameters. The time required to train and test a model can depend upon the choice of its hyperparameters. A hyperparameter is usually of continuous or integer type with millions of possible values. Hyperparameter optimization generally refers to determining the values for hyperparameters that result in a model with the most favorable target characteristics, such as accuracy.

### BRIEF SUMMARY

This summary is not intended to identify only key or essential features of the described subject matter, nor is it intended to be used in isolation to determine the scope of the described subject matter. The subject matter should be understood by reference to appropriate portions of the entire specification of this patent, any or all drawings, and each claim.

In one embodiment, the present disclosure relates to an apparatus comprising a processor and memory comprising instructions that when executed by the processor cause the processor to perform one or more of: identify a list of hyperparameters associated with a machine learning (ML) model, the list of hyperparameters comprising hyperparameters ordered based on influence on accuracy of the ML model, the list of hyperparameters including a first hyperparameter and a second hyperparameter having less influence on accuracy of the ML model than the first hyperparameter; generate a first copy of the ML model for optimization of the first hyperparameter, wherein the first copy corresponds to a first hyperparameter combination and utilizes a default value for the second hyperparameter; generate a second copy of the ML model for optimization of the first and second hyperparameters, wherein the second copy corresponds to a second hyperparameter combination; optimize the first and second copies of the ML model with a genetic algorithm to produce a first hyperparameter value associated with the first copy of the ML model and first and second hyperparameter values associated with the second copy of the ML model; identify accuracy of the first copy of the ML model using the first hyperparameter value associated with the first copy of the ML model for the first hyperparameter and the default value for the second hyperparameter; identify accuracy of the second copy of the ML model using the first hyperparameter value associated with the second copy of the ML model for the first hyperparameter and the second hyperparameter value associated with the second copy of the ML model for the second hyperparameter; determine the first hyperparameter combination results in a more accurate ML model than the second hyperparameter combination; and create a production ML model based on the first hyperparameter combination.

In various embodiments, the instructions, when executed by the processor, further cause the processor to generate a list of hyperparameter combinations comprising the first and second hyperparameter combinations with the hyperparameter combinations ordered based on accuracy of the first and second copies of the ML model, wherein the first copy of the ML model is more accurate than the second copy of the ML model. In various such embodiments, the list of hyperparameters includes a third hyperparameter ordered between the first and second hyperparameters and the list of hyperparameter combinations includes a third hyperparameter combinations ordered below the first and second hyperparameter combinations. In some embodiments, the instructions, when executed by the processor, further cause the processor to classify data with the production ML model. In many embodiments, the instructions, when executed by the processor, further cause the processor to simultaneously optimize the first and second copies of the ML model with the genetic algorithm. In several embodiments, the production ML model utilizes the first hyperparameter value associated with the first copy of the ML model for the first hyperparameter and the default value for the second hyperparameter. In various embodiments, the instructions, when executed by the processor, further cause the processor to generate the list of hyperparameters associated with the ML model with a feature importance algorithm.

In one embodiment, the present disclosure relates to at least one non-transitory computer-readable medium comprising a set of instructions that, in response to being executed by a processor circuit, cause the processor circuit to perform one or more of: identify a list of hyperparameters associated with a machine learning (ML) model, the list of hyperparameters comprising hyperparameters ordered based on influence on accuracy of the ML model, the list of hyperparameters including a first hyperparameter and a second hyperparameter having less influence on accuracy of the ML model than the first hyperparameter; generate a first copy of the ML model for optimization of the first hyperparameter, wherein the first copy corresponds to a first hyperparameter combination and utilizes a default value for the second hyperparameter; generate a second copy of the ML model for optimization of the first and second hyperparameters, wherein the second copy corresponds to a second hyperparameter combination; optimize the first and second copies of the ML model with a genetic algorithm to produce a first hyperparameter value associated with the first copy of the ML model and first and second hyperparameter values associated with the second copy of the ML model; identify accuracy of the first copy of the ML model using the first hyperparameter value associated with the first copy of the ML model for the first hyperparameter and the default value for the second hyperparameter; identify accuracy of the second copy of the ML model using the first hyperparameter value associated with the second copy of the ML model for the first hyperparameter and the second hyperparameter value associated with the second copy of the ML model for the second hyperparameter; determine the first hyperparameter combination as resulting in a more accurate ML model than the second hyperparameter combination; and create a production ML model based on the first hyperparameter combination.

In various embodiments, the set of instructions, in response to execution by the processor circuit, further cause the processor circuit to generate a list of hyperparameter combinations comprising the first and second hyperparameter combinations with the hyperparameter combinations ordered based on accuracy of the first and second copies of the ML model, wherein the first copy of the ML model is more accurate than the second copy of the ML model. In various such embodiments, the list of hyperparameters includes a third hyperparameter ordered between the first and second hyperparameters and the list of hyperparameter combinations includes a third hyperparameter combinations ordered below the first and second hyperparameter combinations. In some embodiments, the set of instructions, in response to execution by the processor circuit, further cause the processor circuit to classify data with the production ML model. In many embodiments, the set of instructions, in response to execution by the processor circuit, further cause the processor circuit to simultaneously optimize the first and second copies of the ML model with the genetic algorithm. In several embodiments, the production ML model utilizes the first hyperparameter value associated with the first copy of the ML model for the first hyperparameter and the default value for the second hyperparameter. In various embodiments, the set of instructions, in response to execution by the processor circuit, further cause the processor circuit to generate the list of hyperparameters associated with the ML model with a feature importance algorithm.

In one embodiment, the present disclosure relates to a computer-implemented method, comprising: identifying a list of hyperparameters associated with a machine learning (ML) model, the list of hyperparameters comprising hyperparameters ordered based on influence on accuracy of the ML model, the list of hyperparameters including a first hyperparameter and a second hyperparameter having less influence on accuracy of the ML model than the first hyperparameter; generating a first copy of the ML model for optimization of the first hyperparameter, wherein the first copy corresponds to a first hyperparameter combination and utilizes a default value for the second hyperparameter; generating a second copy of the ML model for optimization of the first and second hyperparameters, wherein the second copy corresponds to a second hyperparameter combination; optimizing the first and second copies of the ML model with a genetic algorithm to produce a first hyperparameter value associated with the first copy of the ML model and first and second hyperparameter values associated with the second copy of the ML model; identifying accuracy of the first copy of the ML model using the first hyperparameter value associated with the first copy of the ML model for the first hyperparameter and the default value for the second hyperparameter; identifying accuracy of the second copy of the ML model using the first hyperparameter value associated with the second copy of the ML model for the first hyperparameter and the second hyperparameter value associated with the second copy of the ML model for the second hyperparameter; determining the first hyperparameter combination as resulting in a more accurate ML model than the second hyperparameter combination; and creating a production ML model based on the first hyperparameter combination.

In various embodiments, the computer-implemented includes generating a list of hyperparameter combinations comprising the first and second hyperparameter combinations with the hyperparameter combinations ordered based on accuracy of the first and second copies of the ML model, wherein the first copy of the ML model is more accurate than the second copy of the ML model. In some embodiments, the computer-implemented method includes classifying data with the production ML model. In many embodiments, the computer-implemented method includes simultaneously optimizing the first and second copies of the ML model with the genetic algorithm. In several embodiments, the production ML model utilizes the first hyperparameter value associated with the first copy of the ML model for the first hyperparameter and the default value for the second hyperparameter. In various embodiments, the computer-implemented method includes generating the list of hyperparameters associated with the ML model with a feature importance algorithm.

### BRIEF DESCRIPTION OF THE SEVERAL VIEWS OF THE DRAWINGS

FIG. 1 illustrates an exemplary operating environment for a hyperparameter optimizer according to one or more embodiments described hereby.

FIG. 2 illustrates various aspects of a hyperparameter optimizer according to one or more embodiments described hereby.

FIG. 3 illustrates exemplary machine learning (ML) model copies in conjunction with an optimization manager and a genetic algorithm according to one or more embodiments described hereby.

FIG. 4 illustrates an exemplary hyperparameter combinations list in conjunction with an output controller according to one or more embodiments described hereby.

FIGS. 5A and 5B illustrate an exemplary logic flow according to one or more embodiments described hereby.

FIG. 6 illustrates exemplary aspects of a computing system according to one or more embodiments described hereby.

FIG. 7 illustrates exemplary aspects of a communications architecture according to one or more embodiments described hereby.

### DETAILED DESCRIPTION

Various embodiments are generally directed to techniques for optimizing ranked hyperparameters, such as optimizing different combinations of ranked hyperparameters, for instance. Some embodiments are particularly directed using a genetic or Bayesian algorithm to identify and optimize different combinations of hyperparameters for a machine learning (ML) model. Many embodiments construct a search using a genetic algorithm that prioritizes the most important hyperparameters in influencing model performance. These and other embodiments are described and claimed.

Some challenges facing hyperparameter optimization include searching for the optimum combination of hyperparameters for an ML model. For instance, existing techniques (e.g., grid searching) costs excessive compute time and money because the existing techniques do not prioritize the search on the hyperparameters that are most important in influencing model performance. This issue is compounded as the number of hyperparameters for the model increases. These and other factors may result in poorly optimized hyperparameters leading to underperforming ML models or inefficiently optimized hyperparameters requiring excessive resources. Such limitations can drastically reduce the practicality and accessibility of optimized ML models, contributing expensive and inefficient systems, devices, and techniques.

Various embodiments described hereby may include a hyperparameter optimizer that prioritizes a hyperparameter search for a machine learning model by utilizing a hyperparameter ranking list comprising hyperparameters ranked by importance on influencing the model performance. The hyperparameter ranking list may be utilized to construct a search that prioritizes the most important hyperparameters. In many embodiments, a search for the optimum combination of hyperparameters for the target dataset is performed by tasking a genetic or Bayesian algorithm with optimizing different combinations of hyperparameters for multiple copies of the ML model. In several embodiments, the genetic algorithm may simultaneously optimize the different combinations of hyperparameters for the multiple copies of the ML model. For example, a first copy of the ML model may only have the most important hyperparameter as an option to optimize, a second copy of the model may have the top two most important hyperparameters as an option to optimize, and so forth until there are as many copies of the ML model as there are hyperparameters that are identified for optimization (e.g., any number up to the total number of hyperparameters). In various embodiments, utilizing this method can enable the genetic algorithm to prioritize searching the most important hyperparameters, while deprioritizing the search for the less important hyperparameters, resulting in more efficient and effective hyperparameter optimization. In various embodiments, the ranked importance of the hyperparameters and the combination of hyperparameters, including corresponding values, with optimum performance on the target dataset can be output. Further, the combination of hyperparameters, and the corresponding values, with optimum performance can be utilized to generate a more economical production ML model with improved performance.

In these and other ways, components and techniques described hereby identify hyperparameters that contribute most to variation in performance of a ML model and exploit them in an intelligent search using a Bayesian or genetic algorithm to significantly reduce developer effort, compute time, and resources required for the search, resulting in several technical effects and advantages over conventional computer technology, including increased capabilities and improved efficiency. In various embodiments, one or more of the aspects, techniques, and/or components described hereby may be implemented in a practical application via one or more computing devices, and thereby provide additional and useful functionality to the one or more computing devices, resulting in more capable, better functioning, and improved computing devices. For instance, the practical application may include improving computer functions for efficient identification of optimal combinations of hyperparameters and/or efficient generation of accurate production ML models. Further, one or more of the aspects, techniques, and/or components described hereby may be utilized to improve the technical fields of one or more of data processing, artificial intelligence, hyperparameter optimization, machine learning, genetic algorithms, and efficient computing.

In several embodiments, components described hereby may provide specific and particular manners of to enable the efficient hyperparameter optimization and/or ML model generation. In several such embodiments, for example, the specific and particular manners include generating multiple copies of an ML model with different combinations of optimizable hyperparameters and tasking a genetic or Bayesian algorithm with optimizing the different combinations of hyperparameters. In many embodiments, one or more of the components described hereby may be implemented as a set of rules that improve computer-related technology by allowing a function not previously performable by a computer that enables an improved technological result to be achieved. For example, the function allowed may include one or more of: identifying a list of hyperparameters associated with a machine learning (ML) model, the list of hyperparameters comprising hyperparameters ordered based on influence on accuracy of the ML model, the list of hyperparameters including a first hyperparameter and a second hyperparameter having less influence on accuracy of the ML model than the first hyperparameter; generating a first copy of the ML model for optimization of the first hyperparameter, wherein the first copy corresponds to a first hyperparameter combination and utilizes a default value for the second hyperparameter; generating a second copy of the ML model for optimization of the first and second hyperparameters, wherein the second copy corresponds to a second hyperparameter combination; optimizing the first and second copies of the ML model with a genetic algorithm to produce a first hyperparameter value associated with the first copy of the ML model and first and second hyperparameter values associated with the second copy of the ML model; identifying accuracy of the first copy of the ML model using the first hyperparameter value associated with the first copy of the ML model for the first hyperparameter and the default value for the second hyperparameter; identifying accuracy of the second copy of the ML model using the first hyperparameter value associated with the second copy of the ML model for the first hyperparameter and the second hyperparameter value associated with the second copy of the ML model for the second hyperparameter; determining the first hyperparameter combination as resulting in a more accurate ML model than the second hyperparameter combination; and creating a production ML model based on the first hyperparameter combination.

With general reference to notations and nomenclature used hereby, one or more portions of the detailed description which follows may be presented in terms of program procedures executed on a computer or network of computers. These procedural descriptions and representations are used by those skilled in the art to effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in many cases, in any of the operations described hereby that form part of one or more embodiments. Rather, these operations are machine operations. Useful machines for performing operations of various embodiments include general purpose digital computers as selectively activated or configured by a computer program stored within that is written in accordance with the teachings hereby, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

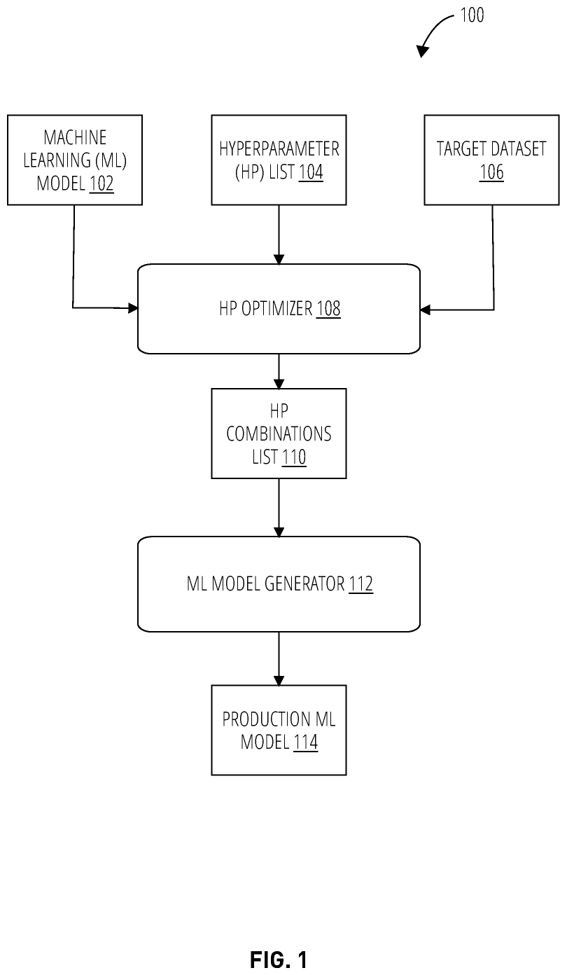

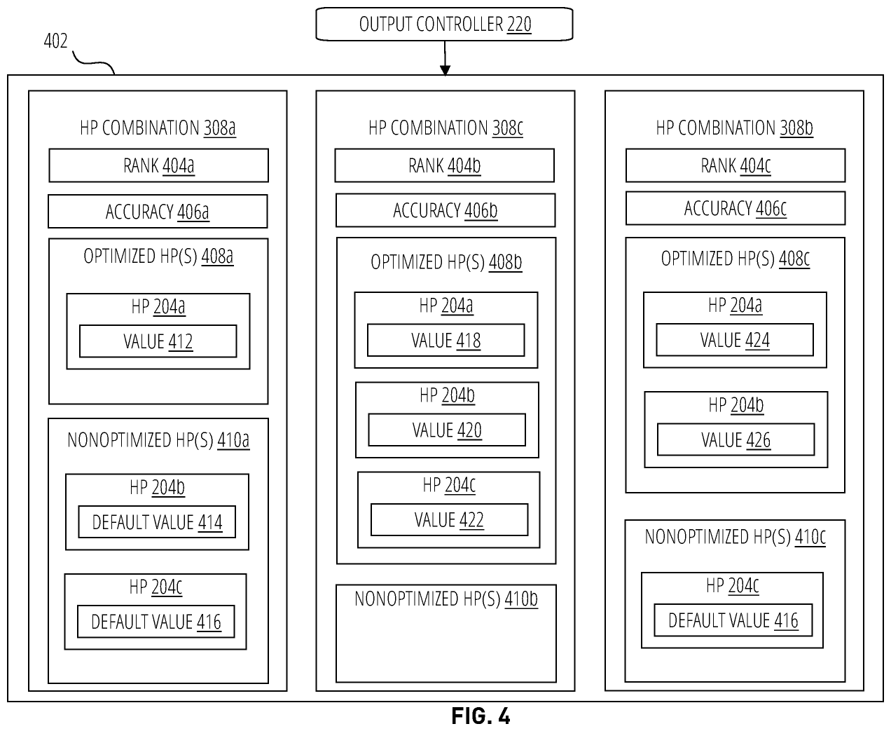

FIG. 1 illustrates an exemplary operating environment 100 for a hyperparameter (HP) optimizer 108 according to one or more embodiments disclosed hereby. Operating environment 100 may include ML model 102, HP list 104, target dataset 106, HP optimizer 108, HP combinations list 110, ML model generator 112, and production ML model 114. In many embodiments, HP optimizer 108 may generate HP combinations list 110 based on ML model 102, HP list 104, and target dataset 106. In some such embodiments, ML model generator 112 may produce production ML model 114 based, at least in part, on HP combinations list 110. In several embodiments, the HP combinations list 110 may include different combinations of optimized hyperparameters that are ranked based on accuracy of the resulting ML model on target dataset 106. In some embodiments, FIG. 1 may include one or more components that are the same or similar to one or more other components of the present disclosure. Further, one or more components of FIG. 1, or aspects thereof, may be incorporated into other embodiments of the present disclosure, or excluded from the disclosed embodiments, without departing from the scope of this disclosure. For example, ML model generator 112 and/or production ML model 114 may be incorporated into the embodiment of FIG. 4. In another example, only the top ranked combination in HP combinations list 110 may be provided to ML model generator 112. Additionally, one or more components of other embodiments of the present disclosure, or aspects thereof, may be incorporated into one or more components of FIG. 1, without departing from the scope of this disclosure. Embodiments are not limited in this context.

As previously mentioned, ML model 102, HP list 104, and target dataset 106 may be provided to HP optimizer 108 as input. In various embodiments, ML model 102 may include, or utilize, one or more of a neural networks, decision trees, random forests, logistic regressions, and k-nearest neighbors. Generally, the ML model 102 may be utilized to identify patterns and insights in the target dataset 106. In some embodiments, the target dataset 106 may include real data or empirical data. In many embodiments, the HP list 104 may include a list of hyperparameters for the ML model 102 ranked based on importance in influencing the model performance. In some embodiments, HP optimizer 108 includes a user interface for receiving one or more of the ML model 102, HP list 104, and target dataset 106.

In one or more embodiments, the HP optimizer 108 may generate HP list 104. In some embodiments, the HP list 104 may be generated based on the target dataset 106. In other embodiments, the HP list 104 may be generated based on one or more synthetic datasets. In other such embodiments, the synthetic datasets may be smaller than the target dataset 106 and improve efficiency. For example, the synthetic datasets could be created with any number of columns and different, desirable statistical features. A number of trials may be conducted on the synthetic datasets where the ML model 102 is fit to the dataset using random hyperparameters combinations. For example, HP list 104 may be generated via a random search on the synthetic datasets that is performed over the hyperparameter space with the ML model to produce a table linking the values for each tested hyperparameter to the average performance over the synthetic datasets. In several embodiments, each row in the table linking the random hyperparameter combinations to the accuracy of the corresponding ML model may correspond to a trial. In various embodiments, the number of trials performed is user-specified. In some embodiments, the number of trials performed is correlated with the number of hyperparameters of the ML model. After sufficient trials have been conducted in this random search, a feature importance algorithm, such as Boruta, may be applied to a target dataset to identify which hyperparameters were the most important in influencing performance of the model.

In several embodiments, HP optimizer 108 may optimizing the different combinations of hyperparameters while prioritizing the optimization on the most influential hyperparameters as indicated by HP list 104. In some embodiments, HP optimizer 108 may generate HP combinations list 110. In some such embodiments, HP optimizer 108 may provide one or more portions of HP combinations list 110 to ML model generator 112 for generation of production ML model 114. In various embodiments, production ML model 114 may be used to classify data.

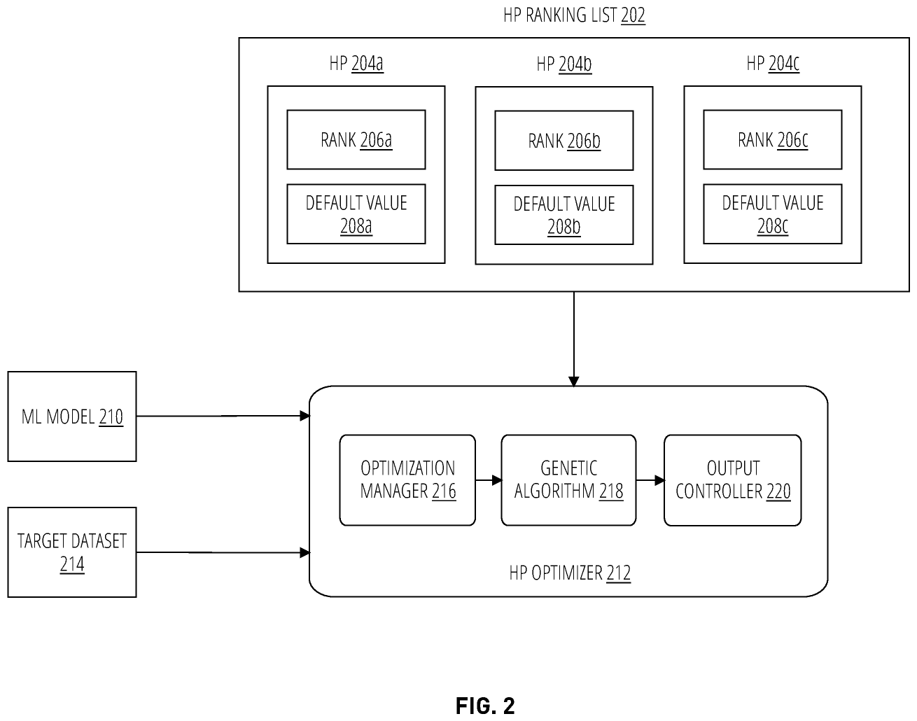

FIG. 2 illustrates various aspects of an HP optimizer 212 according to one or more embodiments disclosed hereby. The HP optimizer 212 may include optimization manager 216, genetic algorithm 218, and output controller 220. In various embodiments, the HP optimizer 212 may receive HP ranking list 202, ML model 210, and target dataset 214 as inputs. The HP ranking list 202 may include one or more hyperparameters ranked based on importance on influencing the ML model 210. Additionally, each hyperparameter in the HP ranking list 202 may include a default value. In the illustrated embodiment, HP ranking list 202 includes HP 204a with rank 206a and default value 208a, HP 204b with rank 206b and default value 208b, and HP 204c with rank 206c and default value 208c. In some embodiments, FIG. 2 may include one or more components that are the same or similar to one or more other components of the present disclosure. For example, HP optimizer 212 may be the same or similar to HP optimizer 108. Further, one or more components of FIG. 2, or aspects thereof, may be incorporated into other embodiments of the present disclosure, or excluded from the disclosed embodiments, without departing from the scope of this disclosure. For example, a Bayesian algorithm may be utilized in place of genetic algorithm 218 without departing from the scope of this disclosure. Additionally, one or more components of other embodiments of the present disclosure, or aspects thereof, may be incorporated into one or more components of FIG. 2, without departing from the scope of this disclosure. Embodiments are not limited in this context.

In many embodiments, hyperparameter HP optimizer 212 prioritizes a hyperparameter search for a machine learning model by utilizing HP ranking list 202 comprising hyperparameters ranked by importance on influencing the model performance. Accordingly, HP ranking list 202 includes HP 204a with first rank 206a and default value 208a, HP 204b with second rank 206b and default value 208b, and HP 204c with third rank 206c and default value 208c. In various embodiments, the default values may be determined and/or provided by the developer of the ML model 210.

The HP ranking list 202 may be utilized by HP optimizer 212 to construct a search that prioritizes the most important hyperparameters. It will be appreciated that although three hyperparameters (HPs 204a, 204b, 204c) are included in the illustrated embodiments, any number of hyperparameters may be included without departing from the scope of this disclosure. Additionally, some hyperparameters may not be the target of optimization in any of the ML model copies. For example, if the HP list includes 15 hyperparameters, the bottom ten may always be nonoptimizable. As will be discussed in more detail below, a search for the optimum combination of hyperparameters for the target dataset 214 is performed by tasking genetic algorithm 218 with optimizing different combinations of hyperparameters for multiple copies of the ML model. In some embodiments, a Bayesian optimization algorithm, a grid search, or a random search may be utilized in place of genetic algorithm 218. In various embodiments, output controller 220 may interpret and/or format the results of the genetic algorithm 218.

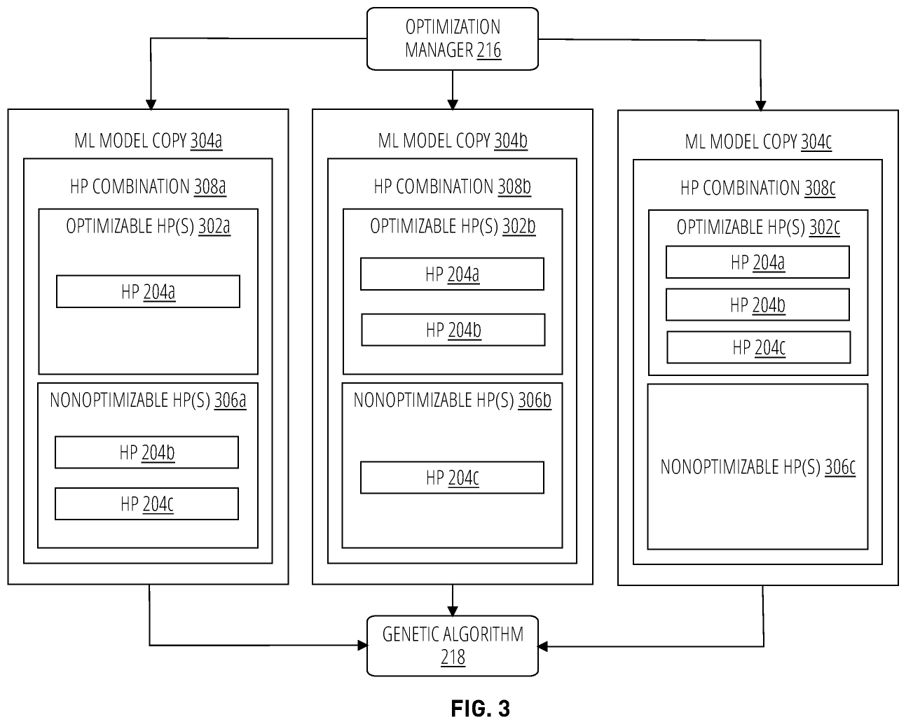

FIG. 3 illustrates ML model copies 304a, 304b, 304c in conjunction with optimization manager 216 and genetic algorithm 218 according to one or more embodiments disclosed hereby. In various embodiments, optimization manager 216 may generate the ML model copies 304a, 304b, 304c and provide them to genetic algorithm 218 as input. In many embodiments, each ML model copy may include a different HP combination with a set of optimizable HPs and a set of nonoptimizable HPs. In the illustrated embodiment, ML model copy 304a comprises HP combination 308a with optimizable HP(s) 302a including HP 204a and nonoptimizable HP(s) 306a including HP 204b and HP 204c; ML model copy 304b comprises HP combination 308b with optimizable HP(s) 302b including HP 204a and HP 204b and nonoptimizable HP(s) 306b including HP 204c; and ML model copy 304c comprises HP combination 308c with optimizable HP(s) 302c including HP 204a, HP 204b, and HP 204c and nonoptimizable HP(s) 306a being empty. In some embodiments, FIG. 3 may include one or more components that are the same or similar to one or more other components of the present disclosure. Further, one or more components of FIG. 3, or aspects thereof, may be incorporated into other embodiments of the present disclosure, or excluded from the disclosed embodiments, without departing from the scope of this disclosure. For example, HP combinations list 110 may include one or more of HP combination 308a, 308b, 308c may be included in HP combinations list 110 without departing from the scope of this disclosure. Additionally, one or more components of other embodiments of the present disclosure, or aspects thereof, may be incorporated into one or more components of FIG. 3, without departing from the scope of this disclosure. For example, optimizable HP(s) 302a, 302b, 302c may include one or more additional hyperparameters. In another example, nonoptimizable HP(s) 306a, 306b, 306c may include one or more additional hyperparameters. Embodiments are not limited in this context.

In several embodiments, the genetic algorithm 218 may simultaneously (e.g., in a race-manner) optimize the different combinations of hyperparameters for the multiple copies of the ML model. For example, ML model copy 304a may only have the most important hyperparameter (i.e., HP 204a) as an option to optimize, ML model copy 304b may have the top two most important hyperparameters (i.e., HP 204a, 204b) as an option to optimize, and ML model copy 304c may have the top three most important hyperparameters (i.e., HP 204a, 204b, 204c) as an option to optimize. In various embodiments, utilizing this method can enable the genetic algorithm 218 to prioritize searching the most important hyperparameters, while deprioritizing the search for the less important hyperparameters. In the illustrated embodiment, HP 204a is searched/optimized 100% of the time, HP 204b is searched/optimized 66% of the time, and HP 204c is searched/optimized 33% of the time by genetic algorithm 218. It will be appreciated that although three ML model copies 304a, 304b, 304c (corresponding to combinations of HPs 204a, 204b, 204c) are included in the illustrated embodiments, the number of ML model copies may be any number up to the maximum number of possible combinations of hyperparameters in the corresponding hyperparameter ranking list without departing from the scope of this disclosure.

FIG. 4 illustrates an HP combinations list 402 in conjunction with output controller 220 according to one or more embodiments disclosed hereby. In various embodiments, output controller 220 may produce HP combinations list 402 based on the output of genetic algorithm 218. For instance, genetic algorithm 218 may generate accuracies for each of the ML model copies and values for each of the optimizable hyperparameters in the corresponding hyperparameter combinations. The output controller 220 may then produce HP combinations list 402. In the illustrated embodiment, HP combinations list 402 comprises: HP combination 308a with rank 404a, accuracy 406a, optimized HP(s) 408a including HP 204a with value 412, and nonoptimized HP(s) 410a including HP 204b with default value 414 and HP 204c with default value 416; HP combination 308c with rank 404b, accuracy 406b, optimized HP(s) 408b including HP 204a with value 418, HP 204b with value 420, and HP 204c with value 422, and nonoptimized HP(s) 410b being empty; and HP combination 308b with rank 404c, accuracy 406c, optimized HP(s) 408c including HP 204a with value 424 and HP 204b with value 426, and nonoptimized HP(s) 410c including HP 204c with default value 416. In some embodiments, FIG. 4 may include one or more components that are the same or similar to one or more other components of the present disclosure. For example, HP combinations list 402 may be the same or similar to HP combinations list 110. Further, one or more components of FIG. 4, or aspects thereof, may be incorporated into other embodiments of the present disclosure, or excluded from the disclosed embodiments, without departing from the scope of this disclosure. For example, in some embodiments output controller 220 may only output HP combination 308a as the top ranked hyperparameter combination. In some such examples, the output may merely include HP 204a with value 412. In another example, the HP combinations list 402 may not include nonoptimized HP(s) 410a, 410b, 410c. Additionally, one or more components of other embodiments of the present disclosure, or aspects thereof, may be incorporated into one or more components of FIG. 4, without departing from the scope of this disclosure. For example, HP list 104 may be incorporated into, or output along with, HP combinations list 402. Embodiments are not limited in this context.

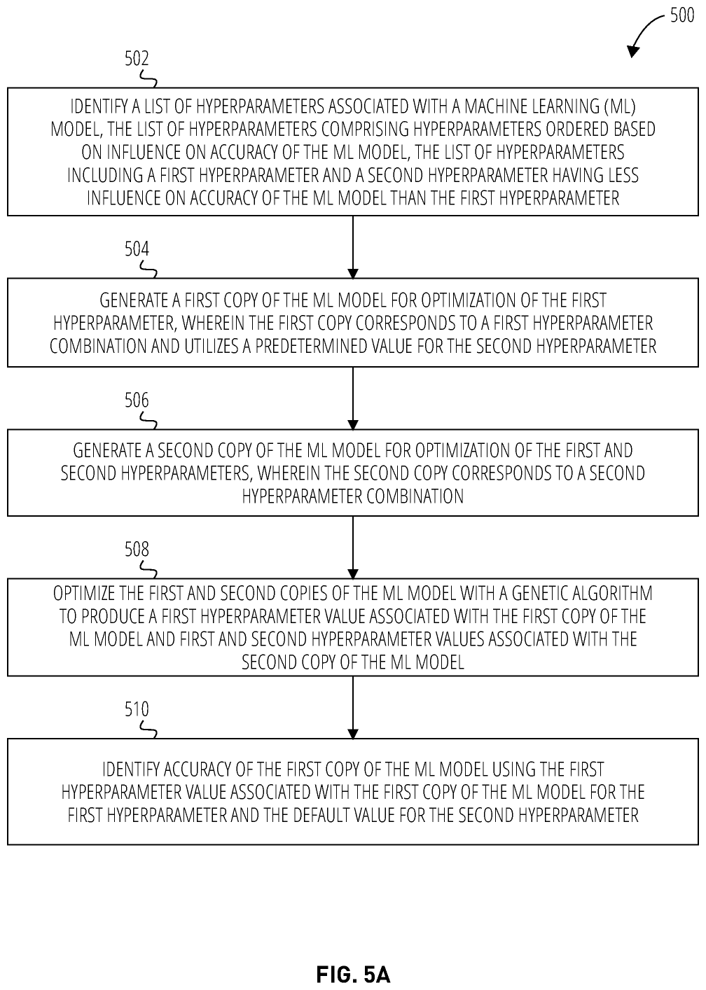

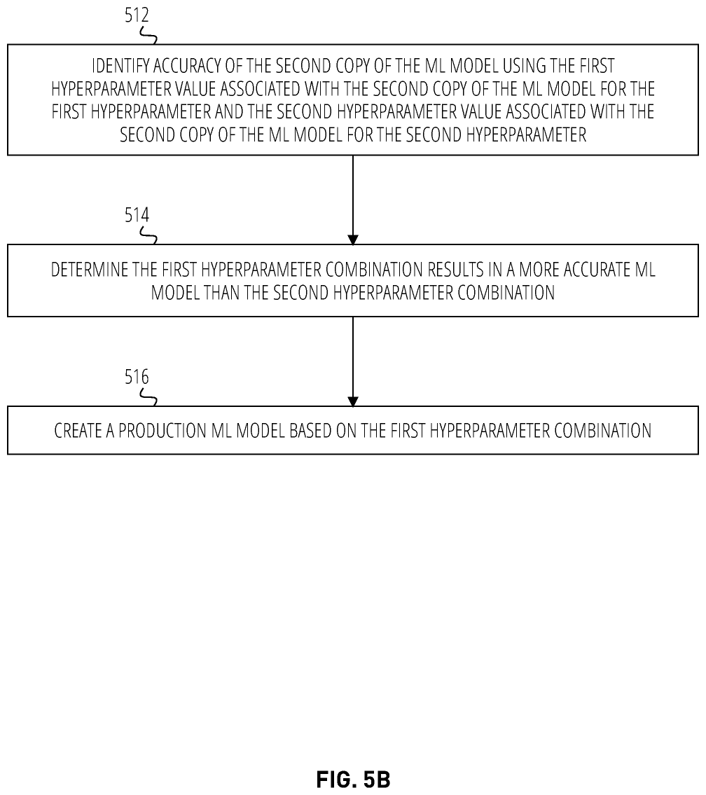

FIGS. 5A and 5B illustrates one embodiment of a logic flow 500, which may be representative of operations that may be executed in various embodiments in conjunction with techniques disclosed hereby. The logic flow 500 may be representative of some or all of the operations that may be executed by one or more components/devices/environments described hereby, such as HP optimizer 108, ML model generator 112, output controller 220, and/or genetic algorithm 218. It will be appreciated that the illustrated embodiment of logic flow 500 does not imply the operations are sequential. The embodiments are not limited in this context.

In the illustrated embodiment, logic flow 500 may begin at block 502. At block 502 “identify a list of hyperparameters associated with a machine learning (ML) model, the list of hyperparameters comprising hyperparameters ordered based on influence on accuracy of the ML model, the list of hyperparameters including a first hyperparameter and a second hyperparameter having less influence on accuracy of the ML model than the first hyperparameter” a list of hyperparameters associated with a ML model may be identified. The list of hyperparameters may be ordered based on influence on accuracy of the ML model and include a first hyperparameter and a second hyperparameter having less influence on accuracy of the ML model than the first hyperparameter. For example, HP optimizer 212 may identify HP ranking list 202 comprising HP 204a and HP 204b having less influence on accuracy of the ML model 210 than HP 204a. In some embodiments, the HP optimizer 212 may generate the HP ranking list 202.

Continuing to block 504 “generate a first copy of the ML model for optimization of the first hyperparameter, wherein the first copy corresponds to a first hyperparameter combination and utilizes a default value for the second hyperparameter” a first copy of the ML model may be generated for optimization of the first hyperparameter. The first copy may correspond to a first hyperparameter combination and utilize a default value for the second hyperparameter. For example, ML model copy 304a may be generated by output controller 220 for optimization of HP 204a and HP 204b may be nonoptimizable and utilize a default value.

Proceeding to block 506 “generate a second copy of the ML model for optimization of the first and second hyperparameters, wherein the second copy corresponds to a second hyperparameter combination” a second copy of the ML model may be generated for optimization of the first and second hyperparameters. The second copy may correspond to a second hyperparameter combination. For example, ML model copy 304b may be generated by output controller 220 for optimization of HP 204a and HP 204b.

At block 508 “optimize the first and second copies of the ML model with a genetic algorithm to produce a first hyperparameter value associated with the first copy of the ML model and first and second hyperparameter values associated with the second copy of the ML model” the first and second copies of the ML model may be optimized with a genetic algorithm to produce a first hyperparameter value associated with the first copy of the ML model and first and second hyperparameter values associated with the second copy of the ML model. For example, ML model copy 304a may be optimized by genetic algorithm 218 to produce value 412 for HP 204a associated with HP combination 308a of ML model copy 304a and ML model copy 304b may be optimized by genetic algorithm 218 to produce value 424 for HP 204a and value 426 for HP 204b associated with HP combination 308b of ML model copy 304b.

Continuing to block 510 “identify accuracy of the first copy of the ML model using the first hyperparameter value associated with the first copy of the ML model for the first hyperparameter and the default value for the second hyperparameter” accuracy of the first copy of the ML model using the first hyperparameter value associated with the first copy of the ML model for the first hyperparameter and the default value for the second hyperparameter may be identified. For example, accuracy 406a may be identified for HP combination 308a associated with ML model copy 304a including value 412 for HP 204a and default value 414 for HP 204b.

Proceeding to block 512 “identify accuracy of the second copy of the ML model using the first hyperparameter value associated with the second copy of the ML model for the first hyperparameter and the second hyperparameter value associated with the second copy of the ML model for the second hyperparameter” accuracy of the second copy of the ML model using the first hyperparameter value associated with the second copy of the ML model for the first hyperparameter and the second hyperparameter value associated with the second copy of the ML model for the second hyperparameter may be identified. For example, accuracy 406c may be identified for HP combination 308b associated with ML model copy 304b including value 424 for HP 204a and value 426 for HP 204b.

At block 514 “determine the first hyperparameter combination results in a more accurate ML model than the second hyperparameter combination” the first hyperparameter combination may be determined to result in a more accurate ML model than the second hyperparameter combination. For example, HP combination 308a may be determined to result in a more accurate ML model than HP combination 308b. In some embodiments, HP combination 308a may be determined to result in a more accurate ML model than HP combination 308b based on accuracy 406a and accuracy 406c. In other embodiments, HP combination 308a may be determined to result in a more accurate ML model than HP combination 308b based on rank 404a and rank 404c.

Continuing to block 516 “create a production ML model based on the first hyperparameter combination” a production ML model may be created based on the first hyperparameter combination. For example, ML model generator 112 may generate production ML model 114 based on the top ranked hyperparameter combination in HP combinations list 110. In some such examples, the top ranked hyperparameter combination in HP combinations list 110 may comprise HP combination 308a. In some embodiments, HP optimizer 108 may just provide ML model generator 112 with the top ranked hyperparameter combination as opposed to multiple hyperparameter combinations in a HP combinations list.

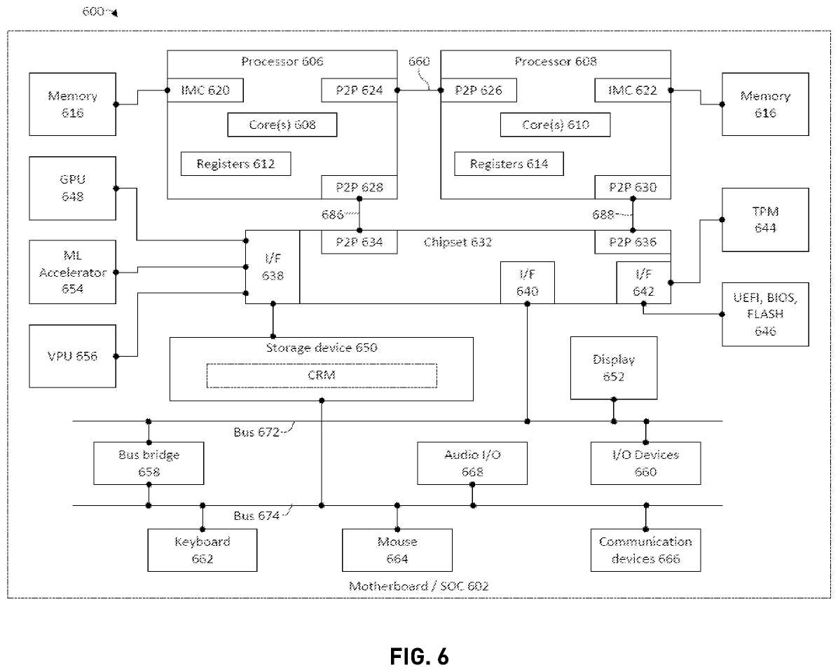

FIG. 6 illustrates an embodiment of a system 600 that may be suitable for implementing various embodiments described hereby. System 600 is a computing system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 600 may have a single processor with one core or more than one processor. Note that the term “processor” refers to a processor with a single core or a processor package with multiple processor cores. In at least one embodiment, the computing system 600, or one or more components thereof, is representative of one or more components described hereby, such as a user interface for interacting with, configuring, or implementing HP optimizer 108, ML model generator 112, output controller 220, and/or genetic algorithm 218. More generally, the computing system 600 is configured to implement all logic, systems, logic flows, methods, apparatuses, and functionality described hereby with reference to FIGS. 1-7. The embodiments are not limited in this context.

As used in this application, the terms “system” and “component” and “module” are intended to refer to a computer-related entity, either hardware, a combination of hardware and software, software, or software in execution, examples of which are provided by the exemplary system 600. For example, a component can be, but is not limited to being, a process running on a processor, a processor, a hard disk drive, multiple storage drives (of optical, solid-state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 600 comprises a motherboard or system-on-chip (SoC) 602 for mounting platform components. Motherboard or system-on-chip (SoC) 602 is a point-to-point (P2P) interconnect platform that includes a first processor 604 and a second processor 606 coupled via a point-to-point interconnect 670 such as an Ultra Path Interconnect (UPI). In other embodiments, the system 600 may be of another bus architecture, such as a multi-drop bus. Furthermore, each of processor 604 and processor 606 may be processor packages with multiple processor cores including core(s) 608 and core(s) 610, respectively. While the system 600 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 604 and chipset 632. Some platforms may include additional components and some platforms may only include sockets to mount the processors and/or the chipset. Furthermore, some platforms may not have sockets (e.g. SoC, or the like).

The processor 604 and processor 606 can be any of various commercially available processors, including without limitation an Intel® processors; AMD® processors; ARM® processors; IBM® processors; and similar processors. Dual microprocessors, multi-core processors, and other multi-processor architectures may also be employed as the processor 604 and/or processor 606. Additionally, the processor 604 need not be identical to processor 606.

Processor 604 includes an integrated memory controller (IMC) 620 and point-to-point (P2P) interface 624 and P2P interface 628. Similarly, the processor 606 includes an IMC 622 as well as P2P interface 626 and P2P interface 630. IMC 620 and IMC 622 couple the processors processor 604 and processor 606, respectively, to respective memories (e.g., memory 616 and memory 618). Memory 616 and memory 618 may be portions of the main memory (e.g., a dynamic random-access memory (DRAM)) for the platform such as double data rate type 3 (DDR3) or type 4 (DDR4) synchronous DRAM (SDRAM). In the present embodiment, the memories memory 616 and memory 618 locally attach to the respective processors (i.e., processor 604 and processor 606). In other embodiments, the main memory may couple with the processors via a bus and shared memory hub.

System 600 includes chipset 632 coupled to processor 604 and processor 606. Furthermore, chipset 632 can be coupled to storage device 650, for example, via an interface (I/F) 638. The I/F 638 may be, for example, a Peripheral Component Interconnect-enhanced (PCI-e). Storage device 650 can store instructions executable by circuitry of system 600 (e.g., processor 604, processor 606, GPU 648, ML accelerator 654, vision processing unit 656, or the like). For example, storage device 650 can store instructions for secondary ML model 102, secondary ML model 338, primary ML model 102 (deleted), or the like. In another example, storage device 650 can store data, such as ML model 102, HP list 104, target dataset 106, HP combinations list 110, production ML model 114, optimizable HP(s) 302a, 302b, 302c, or HP combinations list 402.

Processor 604 couples to a chipset 632 via P2P interface 628 and P2P 634 while processor 606 couples to a chipset 632 via P2P interface 630 and P2P 636. Direct media interface (DMI) 676 and DMI 678 may couple the P2P interface 628 and the P2P 634 and the P2P interface 630 and P2P 636, respectively. DMI 676 and DMI 678 may be a high-speed interconnect that facilitates, e.g., eight Giga Transfers per second (GT/s) such as DMI 3.0. In other embodiments, the processor 604 and processor 606 may interconnect via a bus.

The chipset 632 may comprise a controller hub such as a platform controller hub (PCH). The chipset 632 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 632 may comprise more than one controller hub such as a chipset with a memory controller hub, a graphics controller hub, and an input/output (I/O) controller hub.

In the depicted example, chipset 632 couples with a trusted platform module (TPM) 644 and UEFI, BIOS, FLASH circuitry 646 via I/F 642. The TPM 644 is a dedicated microcontroller designed to secure hardware by integrating cryptographic keys into devices. The UEFI, BIOS, FLASH circuitry 646 may provide pre-boot code.

Furthermore, chipset 632 includes the I/F 638 to couple chipset 632 with a high-performance graphics engine, such as, graphics processing circuitry or a graphics processing unit (GPU) 648. In other embodiments, the system 600 may include a flexible display interface (FDI) (not shown) between the processor 604 and/or the processor 606 and the chipset 632. The FDI interconnects a graphics processor core in one or more of processor 604 and/or processor 606 with the chipset 632.

Additionally, ML accelerator 654 and/or vision processing unit 656 can be coupled to chipset 632 via I/F 638. ML accelerator 654 can be circuitry arranged to execute ML related operations (e.g., training, inference, etc.) for ML models. Likewise, vision processing unit 656 can be circuitry arranged to execute vision processing specific or related operations. In particular, ML accelerator 654 and/or vision processing unit 656 can be arranged to execute mathematical operations and/or operands useful for machine learning, neural network processing, artificial intelligence, vision processing, etc.

Various I/O devices 660 and display 652 couple to the bus 672, along with a bus bridge 658 which couples the bus 672 to a second bus 674 and an I/F 640 that connects the bus 672 with the chipset 632. In one embodiment, the second bus 674 may be a low pin count (LPC) bus. Various devices may couple to the second bus 674 including, for example, a keyboard 662, a mouse 664 and communication devices 666.

Furthermore, an audio I/O 668 may couple to second bus 674. Many of the I/O devices 660 and communication devices 666 may reside on the motherboard or system-on-chip(SoC) 602 while the keyboard 662 and the mouse 664 may be add-on peripherals. In other embodiments, some or all the I/O devices 660 and communication devices 666 are add-on peripherals and do not reside on the motherboard or system-on-chip(SoC) 602.

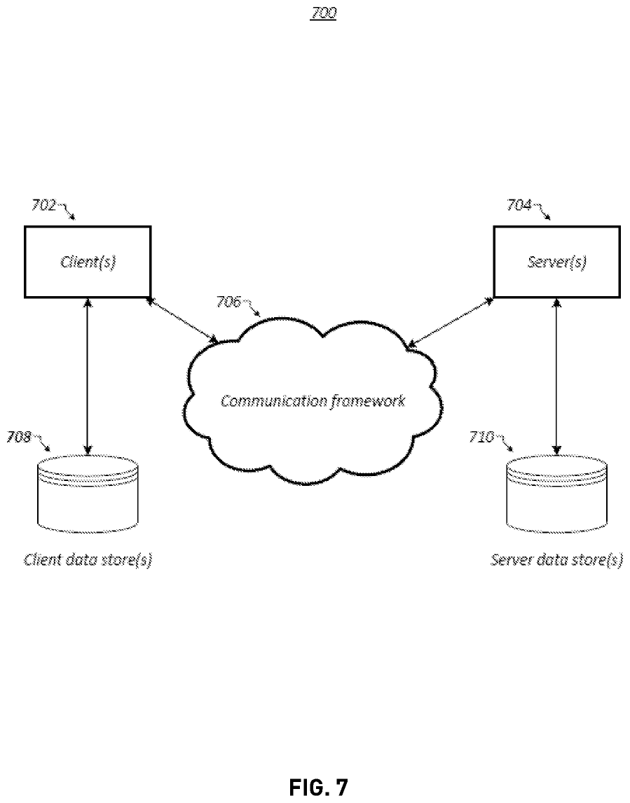

FIG. 7 illustrates a block diagram of an exemplary communications architecture 700 suitable for implementing various embodiments as previously described, such as communications between HP optimizer 108 and ML model generator 112. The communications architecture 700 includes various common communications elements, such as a transmitter, receiver, transceiver, radio, network interface, baseband processor, antenna, amplifiers, filters, power supplies, and so forth. The embodiments, however, are not limited to implementation by the communications architecture 700.

As shown in FIG. 7, the communications architecture 700 comprises includes one or more clients 702 and servers 704. In some embodiments, communications architecture may include or implement one or more portions of components, applications, and/or techniques described hereby. The clients 702 and the servers 704 are operatively connected to one or more respective client data stores 708 and server data stores 710 that can be employed to store information local to the respective clients 702 and servers 704, such as cookies and/or associated contextual information. In various embodiments, any one of servers 704 may implement one or more of logic flows or operations described hereby, such as in conjunction with storage of data received from any one of clients 702 on any of server data stores 710. In one or more embodiments, one or more of client data store(s) 708 or server data store(s) 710 may include memory accessible to one or more portions of components, applications, and/or techniques described hereby.

The clients 702 and the servers 704 may communicate information between each other using a communication framework 706. The communications framework 706 may implement any well-known communications techniques and protocols. The communications framework 706 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 706 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100 (deleted)/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 702 and the servers 704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described hereby. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated hereby.

What is claimed is:

1. An apparatus, the apparatus comprising:
a processor; and
memory comprising instructions that when executed by the processor cause the processor to:
identify a list of hyperparameters associated with a machine learning (ML) model, the list of hyperparameters comprising hyperparameters ordered based on influence on accuracy of the ML model, the list of hyperparameters including a first hyperparameter and a second hyperparameter having less influence on accuracy of the ML model than the first hyperparameter;
generate a first copy of the ML model for optimization of the first hyperparameter, wherein the first copy corresponds to a first hyperparameter combination and utilizes a default value for the second hyperparameter;
generate a second copy of the ML model for optimization of the first and second hyperparameters, wherein the second copy corresponds to a second hyperparameter combination;
optimize the first and second copies of the ML model with a genetic algorithm to produce a first hyperparameter value associated with the first copy of the ML model and first and second hyperparameter values associated with the second copy of the ML model;
identify accuracy of the first copy of the ML model using the first hyperparameter value associated with the first copy of the ML model for the first hyperparameter and the default value for the second hyperparameter;
identify accuracy of the second copy of the ML model using the first hyperparameter value associated with the second copy of the ML model for the first hyperparameter and the second hyperparameter value associated with the second copy of the ML model for the second hyperparameter;
determine the first hyperparameter combination results in a more accurate ML model than the second hyperparameter combination; and
create a production ML model based on the first hyperparameter combination.

2. The apparatus of claim 1, wherein the instructions, when executed by the processor, further cause the processor to generate a list of hyperparameter combinations comprising the first and second hyperparameter combinations with the hyperparameter combinations ordered based on accuracy of the first and second copies of the ML model, wherein the first copy of the ML model is more accurate than the second copy of the ML model.

3. The apparatus of claim 2, wherein the list of hyperparameters includes a third hyperparameter ordered between the first and second hyperparameters and the list of hyperparameter combinations includes a third hyperparameter combinations ordered below the first and second hyperparameter combinations.

4. The apparatus of claim 1, wherein the instructions, when executed by the processor, further cause the processor to classify data with the production ML model.

5. The apparatus of claim 1, wherein the instructions, when executed by the processor, further cause the processor to simultaneously optimize the first and second copies of the ML model with the genetic algorithm.

6. The apparatus of claim 1, wherein the production ML model utilizes the first hyperparameter value associated with the first copy of the ML model for the first hyperparameter and the default value for the second hyperparameter.

7. The apparatus of claim 1, wherein the instructions, when executed by the processor, further cause the processor to generate the list of hyperparameters associated with the ML model with a feature importance algorithm.

8. At least one non-transitory computer-readable medium comprising a set of instructions that, in response to being executed by a processor circuit, cause the processor circuit to:
identify a list of hyperparameters associated with a machine learning (ML) model, the list of hyperparameters comprising hyperparameters ordered based on influence on accuracy of the ML model, the list of hyperparameters including a first hyperparameter and a second hyperparameter having less influence on accuracy of the ML model than the first hyperparameter;
generate a first copy of the ML model for optimization of the first hyperparameter, wherein the first copy corresponds to a first hyperparameter combination and utilizes a default value for the second hyperparameter;
generate a second copy of the ML model for optimization of the first and second hyperparameters, wherein the second copy corresponds to a second hyperparameter combination;
optimize the first and second copies of the ML model with a genetic algorithm to produce a first hyperparameter value associated with the first copy of the ML model and first and second hyperparameter values associated with the second copy of the ML model;
identify accuracy of the first copy of the ML model using the first hyperparameter value associated with the first copy of the ML model for the first hyperparameter and the default value for the second hyperparameter;
identify accuracy of the second copy of the ML model using the first hyperparameter value associated with the second copy of the ML model for the first hyperparameter and the second hyperparameter value associated with the second copy of the ML model for the second hyperparameter;
determine the first hyperparameter combination as resulting in a more accurate ML model than the second hyperparameter combination; and
create a production ML model based on the first hyperparameter combination.

9. The at least one non-transitory computer-readable medium of claim 8, wherein the set of instructions, in response to execution by the processor circuit, further cause the processor circuit to generate a list of hyperparameter combinations comprising the first and second hyperparameter combinations with the hyperparameter combinations ordered based on accuracy of the first and second copies of the ML model, wherein the first copy of the ML model is more accurate than the second copy of the ML model.

10. The non-transitory computer-readable medium of claim 9, wherein the list of hyperparameters includes a third hyperparameter ordered between the first and second hyperparameters and the list of hyperparameter combinations includes a third hyperparameter combinations ordered below the first and second hyperparameter combinations.

11. The non-transitory computer-readable medium of claim 8, wherein the set of instructions, in response to execution by the processor circuit, further cause the processor circuit to classify data with the production ML model.

12. The non-transitory computer-readable medium of claim 8, wherein the set of instructions, in response to execution by the processor circuit, further cause the processor circuit to simultaneously optimize the first and second copies of the ML model with the genetic algorithm.

13. The non-transitory computer-readable medium of claim 8, wherein the production ML model utilizes the first hyperparameter value associated with the first copy of the ML model for the first hyperparameter and the default value for the second hyperparameter.

14. The non-transitory computer-readable medium of claim 8, wherein the set of instructions, in response to execution by the processor circuit, further cause the processor circuit to generate the list of hyperparameters associated with the ML model with a feature importance algorithm.

15. A computer-implemented method, comprising:
identifying a list of hyperparameters associated with a machine learning (ML) model, the list of hyperparameters comprising hyperparameters ordered based on influence on accuracy of the ML model, the list of hyperparameters including a first hyperparameter and a second hyperparameter having less influence on accuracy of the ML model than the first hyperparameter;
generating a first copy of the ML model for optimization of the first hyperparameter, wherein the first copy corresponds to a first hyperparameter combination and utilizes a default value for the second hyperparameter;
generating a second copy of the ML model for optimization of the first and second hyperparameters, wherein the second copy corresponds to a second hyperparameter combination;
optimizing the first and second copies of the ML model with a genetic algorithm to produce a first hyperparameter value associated with the first copy of the ML model and first and second hyperparameter values associated with the second copy of the ML model;
identifying accuracy of the first copy of the ML model using the first hyperparameter value associated with the first copy of the ML model for the first hyperparameter and the default value for the second hyperparameter;
identifying accuracy of the second copy of the ML model using the first hyperparameter value associated with the second copy of the ML model for the first hyperparameter and the second hyperparameter value associated with the second copy of the ML model for the second hyperparameter;
determining the first hyperparameter combination as resulting in a more accurate ML model than the second hyperparameter combination; and
creating a production ML model based on the first hyperparameter combination.

16. The computer-implemented method of claim 15, comprising generating a list of hyperparameter combinations comprising the first and second hyperparameter combinations with the hyperparameter combinations ordered based on accuracy of the first and second copies of the ML model, wherein the first copy of the ML model is more accurate than the second copy of the ML model.

17. The computer-implemented method of claim 15, comprising classifying data with the production ML model.

18. The computer-implemented method of claim 15, comprising simultaneously optimizing the first and second copies of the ML model with the genetic algorithm.

19. The computer-implemented method of claim 15, wherein the production ML model utilizes the first hyperparameter value associated with the first copy of the ML model for the first hyperparameter and the default value for the second hyperparameter.

20. The computer-implemented method of claim 15, comprising generating the list of hyperparameters associated with the ML model with a feature importance algorithm.
